(19) United States
(12) Patent Application Publication
(10) Pub. No.: US 2003/0078180 A1
(43) Pub. Date: Apr. 24, 2003

(54) Contaminant-tolerant foaming additive

(75) Inventors: Pablo Munoz JR., Houston, TX (US); William Franklin Harris JR., Friendswood, TX (US); David Brian Acker, Woodlands, TX (US); Joel Farrell Siegel, Denver, CO (US)

Correspondence Address: LAW OFFICES OF CHRISTOPHER l. MAKAY, 1634 Milam Building, 115 East Travis Street, San Antonio, TX, 78205, US

(73) Assignee: Benchmark Research & Technology, Inc.

(21) Appl. No.: 10/039,591

(22) Filed: Oct. 24, 2001

(51) Int. Cl. C11D 17/00

(52) U.S. Cl. 510/407; 510/424; 510/426; 510/475; 510/506

(57) ABSTRACT

A composition of an aqueous, an aqueous acid, and an aqueous alkaline foaming additive (“foamer”) functions in a wide pH range and under conditions of salt, alcohol, and hydrocarbon contamination. The foaming additive (“foamer”) composition includes a mixture of a salt of an alkyl ether sulfate surfactant, a polymer or combination of polymers, and either a water miscible solvent for the liquid foamer additive or a silicon compound for a substantially anhydrous foamer additive.

### BACKGROUND OF THE INVENTION

1. Field of the Invention

The present invention relates to a composition of an aqueous, an aqueous acid, and an aqueous alkaline foaming additive that foams with prolonged stabilities across a wide range of pH and in the presence of hardness ions, hydrocarbons, and lower alcohols to at least 20% by volume of the foam.

2. Description of the Related Art

The term “surfactant” is derived from SURFace ACTive AgeNT. A surfactant is a compound that contains a hydrophilic and a hydrophobic segment. When added to water or solvents, a surfactant reduces the surface tension of the systems for the following purposes: wetting, emulsifying, dispersing, foaming, scouring, or lubricating.

Aqueous foams, which may contain surfactants, and various organic, polymeric, or inorganic substances, have been used in applications where one or more of the following are desired: reduced weight, reduced material consumption, increased yield, homogeneous material distribution, and ease of processing. Aqueous foams are also useful in products serving as barriers against sound, temperature, particulate matter, or odor. Examples of applications in which foams are used include construction materials, fire-fighting foams, fireproof coatings, foamed adhesives, surface coatings, paper and textile treatment materials, lightweight ceramics, lightweight landfill covers, and dust barriers. In most of these applications, stable foams with fine pore size are required.

Dispersing air or a gas in a surfactant-containing liquid creates foam. The mechanism of dispersing a gas in a surfactant-containing liquid is thought to be similar to the dispersion of two immiscible liquids during formation of an emulsion, and the theory of foam is quite well developed. Consequently, it is thought that gas bubbles dispersed in a liquid are stabilized in the same manner as emulsions, i.e., by formation of surfactant layers at the gas-liquid interface. The surfactant layers keep the gas bubbles separated and prevent “coalescence,” i.e., the collapsing or merging of small gas bubbles to form larger gas bubbles. In general, denser and more compact surfactant layers form smaller bubbles and retard coalescence.

Over time, the liquid present in the interstices between the individual gas bubbles drains out due to gravity. Depending on the nature and chemical structure of the surfactant in the liquid, lamellar liquid crystalline layers form and arrange at the gas-liquid interface. If the lamellar layers have a low viscosity, the surfactant-containing liquid between individual gas bubbles drains relatively easily, essentially “drying” the foam and rendering it unstable. The foam lamellae can become so thin that small perturbations, such as vibrations, shocks or sudden pressure or temperature changes, cause the remaining foam column to collapse catastrophically. However, if the lamellar surfactant layers have a high viscosity, the transition is delayed. To further extend foam life, film drainage and water evaporation should be reduced, while mechanical strength should be improved.

For the purposes of this disclosure, the term “liquid” will be used to define those fluids that are, for the most part, incompressible; the term “gas” will be used to define those fluids that are substantially compressible. Foam production systems are similar in that they include a to-be-foamed liquid phase, a gas, and equipment designed to combine, mix, and discharge the foam product. However, the foams produced from these similar systems are not necessarily similar. The most obvious difference among foams is persistence, or lifetime, generally defined as drain time, which is the time required for the foam to decompose into the original liquid and gas phases. The chemical composition of the foaming product, and its interaction with the liquid phase, affects the drain time.

Any gas used in excess of the solubility of the gas in the liquid phase, at a given pressure and temperature, is suitable to generate a foam, and so the gas used to foam is preferably inert. The use of air, oxygen, nitrogen, carbon dioxide, methane, flue gas, the inert gases, and combinations thereof, are common choices for the gas portion in a foam. In some applications where it is beneficial to have the gas exhibit some solubility in the liquid, carbon dioxide, may be preferred. Generally, the gas is present in an amount sufficient to foam in the range of from about 5% to about 95% by volume of the resulting foamed composition, but more typically from about 50% to about 90% by volume of the resulting foamed composition. The gas may be compressed and added under pressure to form an “energized” fluid. “Energized” fluids here may be defined as those fluids that contain more than about 5% compressed gas by volume and less than about 95% compressed gas by volume, and which may include foams comprised of a liquid and a compressed gas, there being some disagreement among workers in the field as to what gas volume is required for an “energized” fluid to be properly regarded as a foam. Foam quality is a function of gas content and drainage time.

Presently, a water-wet surface is important as the end result of aqueous-based foamed cleaners. A formulation with surfactants is a desirable component to convert the oil-wet surface left by contact with non-aqueous fluids. Because the oil film can act as a de-foamer, present foamer chemistries fail to maintain a stable foam in its presence. In fact, diesel, other hydrocarbons, or alcohols may be employed as de-foamers. In the presence of hydrocarbons, or alcohols, two additional factors are believed to further accelerate foam decay. First, hydrocarbon or alcohol diffusion through the foam tends to destroy bubbles near the water-hydrocarbon, alcohol interface. Second, surface-active materials in the foam lamellae, which are soluble in the hydrocarbons and alcohols, tend to partition into the contaminant causing sudden collapse of the bubbles at the hydrocarbon interface. The collapse of foams by these contaminants is more severe in foams produced by using surfactants containing long hydrophobic moieties of greater than about 10 carbons.

Hardness ions, such as calcium and magnesium, also tend to have a detrimental effect on the quality of foams, since these ions tend to deleteriously interact with the very foaming agents used to generate the foam. There has been considerable effort expended in making foaming agents less susceptible to hardness ion contamination, e.g. U.S. Pat. Nos. 5,227,100 and 5,443,757, but these inventions do not address the consequences of further contamination by hydrocarbons, alcohols, or provide for stable foams across vide ranges of pH.

U.S. Pat. No. 5,240,639 (Diez, et al.); U.S. Pat. Nos. 5,158,612 and 5,714,001 (Savoly, et al.); U.S. Pat. Nos. 4,618,370 and 4,676,835 (Green, et al.); U.S. Pat. Nos. 5,588,489 and 5,711,801 (Chatterji;, et al.); and U.S. Pat. No. 4,156,615 (Cukier) disclose foaming agent compositions including a mixture of alkyl sulfates and alkyl ether sulfates having improved foaming properties. Diluted compositions use a hydrotrope and water to lower the viscosity, pour point, and cost. U.S. Pat. No. 5,225,095 (DiMaio, et al.), for example, discloses a protein foamer with a polymer stabilizer. The compositions disclosed in these patents claim to produce a high yield, stable foam, yet, do not maintain the foam stable n the presence of contaminants.

U.S. Pat. No. 4,425,243 (Green, et al.) discloses a foaming agent composed of n-octyl dimethylamine oxide, n-decyl dimethylamine oxide, branched decyl dimethylamine oxide, and mixtures thereof, which generates a stable foam even in the presence of brine and hydrocarbons. The foamer is described as generating foam in the process of rotary drilling for oil and gas, exhibiting foaming and stability properties superior to conventional foaming agents presently used in the oil and gas industry. However, the roamer is evaluated only where the maximum hydrocarbon tolerance is from 0.5 to 2.0% using a brine to simulate the water-hardness found in most oil and gas producing areas. Further, the foaming agent does not cover contamination from alcohols or a pH range that would cover all the conditions of foaming acidic or alkaline media.

U.S. Pat. No. 5,882,541 (Achtmann) discloses the use of a biodegradable foam composition for use in fire fighting, which includes an alkyl polyglycoside surfactant, a polyethylene glycol solvent, and xanthan gum as a stabilizer. Achtmann discloses extinguishing hydrocarbon fires without referring to alcohols, pH and/or electrolyte contaminants in the system.

Crosslinked polymers have been added to foam formulations to impart greater stability. However, these crosslinked polymer-stabilized foams may also not be stable upon contact with hydrocarbons. Further, as known to those of ordinary skill in the art, the contamination of the crosslinked polymer-stabilized foam with a hydrocarbon may rot only de-stabilize the foam, bit cause an oil/water emulsion, which may result in subsequent increases in viscosity and corresponding excessive friction pressures. Finally, as a solution that is no longer a foam once the gas has diffused from the liquid, it may be necessary to incorporate substantially more enzyme, chelate, or oxidizer to “break” a crosslinked polymer solution than one that is not crosslinked.

U.S. Pat. No. 4,676,316 (Mitchell) and U.S. Pat. No. 5,105,884 (Sydansk) disclose the use of a crosslinked polyacrylamide, while U.S. Pat. No. 5,129,457 (Sydansk) prefers using an uncrosslinked polymer to make a foamed gel. The preferred surfactants are a C₁₂₋₁₅ ethoxylated ether sulfate surfactant and C₁₂₋₁₄ alpha olefin sulfonate surfactant. Mitchell and Sydansk disclose their inventions as hydrocarbon compatible and stable in light brine and a pH of about 4 to 10. Mitchell and Sydansk both perform testing utilizing residual oil saturation as the hydrocarbon concentration, and claim tolerance to hardness at about 560 ppm of calcium and 160 ppm of magnesium. The crosslinked polymer requires a “breaker” in order for it to revert from a gel to a displaceable liquid. Polyacrylamides have demonstrated reduced stability under contamination by hydrocarbons and high alkalinity.

U.S. Pat. No. 4,440,653 (Briscoe, et al.) disclose the use of non-ionic surfactants that will foam an aqueous alcohol solution containing one or more organic alcohols, with 1 to 3 carbon atoms, in the range from about 50-99% using HPG, HEC, or PVP as a viscosifier. The organic alcohols with 1 to 3 carbon atoms are herein named as “lower alcohols.” Briscoe, et al. do not address the issues of contaminant compatibility of their foamer composition.

U.S. Pat. No. 5,434,192 (Thach, et al.) uses alkyl polyethylene glycol ethers nonionic surfactants, with the alkyl chain including 12 to 13 carbon atoms and 10 to 20 ethylene oxide-repeating units, with a fluorosurfactant as a co-surfactant. Thach, et al. disclose a short ethylene oxide chain alkyl polyethylene glycol ethers for situations in seawater, without going to extremes in pH or hardness tolerance. The hydrocarbon content in the foam is about 2% total in a vapor state, staged in a totally different testing mechanism where contamination is limited to vapor production under pressure. Xanthan gum is the preferred polymer included to aid in the suppression of hydrocarbon vapors. U.S. Pat. Nos. 5,614,473 and 6,113,809 (Dino, et al.) disclose the composition and use of a high purity imidazoline based amphoacetate as a foamer for well boring and stimulation processes as well as secondary and tertiary hydrocarbon recovery applications. The foamer of Dino, et al. is described as one which shows reduced foam detriment due to contact with hydrocarbons and as possessing more tolerance to conventional anionic foaming agents presently used in the oil industry. However, the foamer of Dino, et al. is evaluated where the hydrocarbon content is merely 1% by volume of the foam, where the pH of the fluid conditions in which the foam comes into contact as being narrowly within the range of 5.0 to 5.5. Further, the foamer additive preferred by Dino, et al., is a long chained hydrocarbon containing a minimum of 8 and a maximum of 18 carbons in the hydrophobic aliphatic radical of the foaming surfactant. As has already been discussed, long-chained hydrophobic moieties, like those discussed by Thach, et al. and Dino, et al., are more susceptible to degradation by hydrocarbon contamination than short-chained less-hydrophobic moieties. Fluorosurfactants, like those used by Thach, et al. failed to produce a stable foam in the present testing, and belies any attempt at an environmentally acceptable foamer composition.

Accordingly, there remains a long felt need for a foamer composition suitable for the generation of an aqueous foam that is non-crosslinked, low viscosity, hydrocarbon stable, alcohol stable, hardness ion stable, and stable across a wide range of pH.

### SUMMARY OF THE INVENTION

The present invention is a foamer comprising an anionic surfactant, stabilizers, and other components that can be adjusted to the conditions dictated by the situation under which it is to be utilized. The present invention relates to new foam formulations that will foam with prolonged stabilities in the presence of electrolytes, including hardness ions, hydrocarbons to at least 20% by volume of the foam, and across a wide range of pH. The foamer additive of the present invention has been demonstrated stable in very alkaline solutions as well as in 10% hydrochloric acid solutions.

The present invention relates to new foam formulations that will foam with prolonged stabilities in the presence of hardness ions, hydrocarbons and lower alcohols to at least 20% by volume of the foam, and across a wide range of pH. The foamer additive of the present invention has been demonstrated stable in very alkaline, high hardness ion solutions as well as in 10% hydrochloric acid solutions. The formulations of the present invention include surface-active materials and multi-functional additives, which are selected to produce highly stable foams that will persist in the presence of contaminants.

### DETAILED DESCRIPTION OF THE PREFERRED EMBODIMENTS

There currently exists a need for aqueous or acid foams that are stable across a wide pH range, even upon incidental contact with electrolytes, hardness ions, alcohols, and hydrocarbons, such as may be the case, for instance, in fire extinguishing, and pipeline or plant cleaning operations. The preferred embodiments provide foamer compositions that create a foam, which when foamed properly with a gas, will extend the yield, decrease the density, be pumpable, and will remain stable during and after placement of the foam even in the presence of contaminants The foamer compositions are supplied as liquid concentrates or solid and semi-solid concentrates. The liquid concentrate foamer compositions include a foaming agent, a foam-stabilizing agent, a diluting agent, and if desired a suspending agent. The solid and semi-solid concentrate foamer compositions include a foaming agent, an adsorbing and/or absorbing agent, a free-flowing agent, and a stabilizing agent.

Liquid Concentrate Foamer Compositions

A preferred foaming agent or surfactant used in the liquid concentrate foamer compositions is an ammonium alkyl ether sulfate (AAES), sold commercially by ARC Products, Inc. of Dallas, Tex., as Oil Pro AES-100. This salt of an alkyl ether sulfate is also known as alcohol ether sulfate and ammonium alcohol ethoxylate, with a formula of CₓH₂ₓ₊₁O(C₂H₄O)_{y}SO₃M, where x is an integer from about 6 to about 10, y is a value from about 2 to about 4 and M is an alkaline metal or ammonium ion, or combinations thereof. The short-chained hydrophobic group of the alkyl ether sulfate salt yielded foams with better stability under contamination, better overall expansion and longer half-lives than amine oxides, amphoterics, fluoro-surfactants, alkyl polyglycosides, and other anionic agents typically employed as foamers. Indeed, the adjacent homologs of these series displayed inferior foaming and stability properties in screening tests. Cyclic amine oxides were also found to be inferior in this respect. The liquid concentrate foamer compositions include the foaming agent in a range of about 10% to about 85% by total weight

The liquid concentrate foamer compositions include a foam-stabilizing agent to enhance the stability of the foamed system, especially in the presence of stress brought on the system by changes in pH, temperature, hydrocarbons, hardness ions, etc. Contamination of foamed systems tends to lower the surface tension of the gas bubbles and collapse the foam.

Although many polymers may be suitable alone or in combination as foam stabilizing agents in the foamer composition of the invention, the preferred foam-stabilizing agent is methoxypolyethylene glycol (MPEG) of the formula CH₃O(CH₂CH₂O)ₙH where n is in the range of 100 to 150, and sold commercially as Carbowax® MPEG 5000 by Union Carbide. These foam-stabilizing agents improve the stability of the foam and thereby decrease the drainage rate. The foam-stabilizing agents, when utilized, are preferably present in the foamer in the amount of 0.01% to about 10% by weight of roamer, and may vary, depending upon the targeted density and expected contaminant hardships.

Useful foam-stabilizing polymers include high-viscosity polysaccharides, biopolymers, or synthetic polymers, which are highly interactive with the foaming agent of the foamer compositions. The polymer preferably has a molecular weight between about 1 and about 5 million. Also, the polymer preferably has good water solubility and very low oil solubility. The polymer increases the foam stability by retarding water drainage, reducing water evaporation, and increasing the film thickness. The polymer greatly improves the mechanical strength of the film, serving to “stiffen” the foam produced by such compositions after they are mixed with water. “Stiffen,” in the preferred embodiments means the foam resulting from use of the foamer compositions (liquid concentrates or solid/semi-solid concentrates) is strengthened.

The polymer used in the present invention may be a water-dispersible or water-soluble hydrophilic colloid selected from the group consisting of polysaccharides. These polymers may be used unmodified, as normally isolated from their source materials, or they may be modified as is well known in the polymer art such as by alkylation, hydroxyalkylation, carboxyalkylation, hydroxyalkylation carboxyalkylation, or cationic substitution. Accordingly, the polymer may comprise natural and modified natural polymers and gums such as modified cellulosics, guar, hydroxyalkyl guar, carboxyalkyl guar, carboxyalkyl hydroxyalkyl guar, cationic guar gum, hydrophobically modified guar, hydrophobically modified hydroxyalkyl guar, hydrophobically modified carboxyalkyl guar, hydrophobically modified carboxyalkyl hydroxyalkyl guar, hydrophobically modified cationic guar gum, pectin, alginates, gum acacia, hydroxyalkyl cellulose, carboxyalkyl hydroxyalkyl cellulose, carboxyalkyl cellulose, alkyl ethers of cellulose, hydroxyalkyl methyl cellulose, hydrophobically modified hydroxyalkyl cellulose, hydrophobically modified carboxyalkyl hydroxyalkyl cellulose, hydrophobically modified carboxyalkyl cellulose, hydrophobically modified alkyl ethers of cellulose, hydrophobically modified hydroxyalkyl methyl cellulose, starch, tara gum, gum ghatti, gum arabic, gum tragacanth, locust bean gum, gum karaya, carrageenan, biopolymers such as xanthan gum or welan gum, succinoglucans, and their alkyl hydroxyalkyl, carboxyalkyl, hydroxyalkyl carboxyalkyl, cationic derivatives, and mixtures thereof. Specific examples of modified polymers are carboxymethyl hydroxypropyl guar gum and carboxymethyl hydroxyethyl cellulose. Natural gums useful to the purposes of this invention are hydrophilic polysaccharides composed of monosaccharide units joined by ether linkages (note: glycoside bonds are specific ether links of a sugar to a non-sugar through an oxygen or nitrogen.).

The synthetic polymers useful to the purpose of this invention may be selected from polyimines, methoxypolyethylene glycol, poly(acrylic acid), poly(methacrylic acid), poly(maleic acid-co-ethylene), poly(maleic acid-co-ethylvinylether), poly(maleic acid-co-butylvinylether), poly(maleic acid-co-styrene), poly(maleic acid-co-indene), poly(vinylsulfuric acid), poly(styrenesulfonic acid), dextransulfate, and poly(L-glutamic acid).

The preferred polymers used in this foamer composition are methoxypolyethylene glycols (MPEG) of the formula CH₃O—(CH₂—CH₂—O)ₙ—H where n is in the range of 100 to 150. The MPEG is added to the foamer composition at a concentration from about 1% to about 8% by weight of the total weight of the foamer composition, and more preferably from about 2% to about 5% by weight of the total weight of the foamer composition. A second preferred stabilizing agent is a polymer, with xanthan gum being the most preferred. Xanthan gum may comprise from about 1% to about 10% by weight of the foamer compositions, and preferably from about 2% to about 5% by weight of the foamer compositions.

The liquid concentrate foamer compositions include a diluting agent to provide a diluted foamer composition with a separate stabilizing group. The preferred foaming agent, ammonium alkyl ether sulfate, being a semi-solid in concentrate former is diluted with a preferred diluting agent of a water miscible solvent to lower its pour point and viscosity. The water miscible solvent used to dilute the semi-solid foaming agent can be chosen from a long list of suitable solvents to encompass an environmentally friendly addition, to create a foaming synergy, or to attain a lower price.

Examples include a water miscible solvent where the solvent is selected from the group consisting of aliphatic alcohols, aliphatic ketones, aliphatic esters, aliphatic glycols, aliphatic polyglycols, aliphatic glycol ethers, and mixtures thereof. Water miscible solvents may be selected from a group comprising methanol, ethanol, propanol, isopropanol, butanol, isobutanol, furfural alcohol, tetrahydrofurfural alcohol, acetone, methyl ethyl ketone, diethyl ketone, diacetone alcohol, ethylene glycol, propylene glycol, butylene glycol, glycerine, hexylene glycol, ethyl acetate, butyl acetate, ethylene glycol methyl ether acetate, diethyiene glycol methyl ether acetate, diethylene glycol, triethylene glycol, tetraethylene glycol, polyethylene glycol, dipropylene glycol, tripropylene glycol, polypropylene glycol, ethylene oxide propylene oxide block copolymers, ethylene glycol methyl ether, ethylene glycol ethyl ether, ethylene glycol butyl ether, ethylene glycol dimethyl ether, ethylene glycol methyl butyl ether, diethylene glycol methyl ether, diethylene glycol butyl ether, diethylene glycol dimethyl ether, diethylene glycol methyl butyl ether, dipropylene glycol methyl ethers dipropyiene glycol butyl ether, dipropyiene glycol dimethyl ether, triethylene glycol methyl ether, triethyleneglycol butyl ether, tripropylene glycol methyl ether, tripropylene glycol butyl ether, polyoxyethylene butyl ether, polyoxypropylene butyl ether, tetrahydrofuran, dimethylformamide or combinations thereof. The water miscible solvent includes from about 1% to about 50% by weight of the foamer. It is more preferable to use from about 10% to about 25% by weight of the water miscible solvent in forming the foamer compositions. The preferred water miscible solvent is polyoxyethylene butyl ether glycol sold commercially as Oil Pro BE-5M by ARC Products, Inc. of Dallas, Tex.

The diluted foamer composition includes a suspending agent incorporated therein to suspend the stabilizing agent(s). The suspending agent may be chosen from commercially available amorphous and fumed silicas and aluminosilicates. The preferred suspending agent is fumed silica. Fumed silicas are available commercially from Cabot Corp. as CAB-O-SIL® M-5 grade, and Degussa Corp. as Aerosil® 200. This suspending agent is added to the roamer at concentrations from about 1% to about 10% by weight, and more preferably from about 2% to about 5% by weight of the foamer composition.

Solid or Semi-Solid Foamer Compositions

The solid and semi-solid concentrate liquid concentrate foamer compositions include a foaming agent the same as the liquid concentrate liquid concentrate foamer compositions compositions, which is a salt of an alkyl ether sulfate. The solid and semi-solid concentrate liquid concentrate foamer compositions include the foaming agent in a range of about 15% to about 85% by weight, depending upon the desired end product, which may vary from a soft waxy composition to a free-flowing powder.

The absorbing agent is preferred to be of an essentially non-reactive nature. For example, ammonium and alkaline metal carbonate, silicas, diatomaceous earth, zeolite, micas and other like absorbing materials may be used. The most preferred being diatomaceous earth, available commercially from Eagle-Picher Minerals Inc., as Celatom™. The absorbing agent is added to the foamer composition in a range of about 10% to about 60% by weight, more preferably from about 20% to about 35% by weight. It should be readily apparent to those of ordinary skill in the art that the list of adsorbing and/or absorbing agents, suitable to the purpose of this invention, can be lengthy and well known, and substitution by one or more of those listed here should not depart from the spirit of this invention.

The preferred free-flowing agent used in the liquid concentrate to form a dry composition is fumed silica, in a range of about 1% to about 20% by weight of composition, more preferred in a range of about 8% to about 15% by weight. The concentrations of the adsorbing and/or absorbing agent and the free-flowing agent may be adjusted to allow for a composition that is soft and malleable or a powder.

The solid and semi-solid concentrate former compositions include a stabilizing agent the same as the liquid concentrate foamer compositions, which includes the preferred MPEG and/or xanthan gum. The MPEG may range from about 1% to about 50% by weight of foamer composition, and more preferred in a range of about 10% to about 30% by weight of roamer composition. The xanthan gum may be added in a range of about 1% to about 15% by weight of foamer composition, and more preferred from about 3% to about 6% by weight of foamer composition.

Use of Concentrated Foamer Compositions

Both the liquid concentrate foamer compositions and the solid and semi-solid concentrate foamer compositions may be diluted subsequently with water at the time of the application. The liquid concentrate is preferably diluted from about 0.25% by volume to about 5% by volume of the to-be-foamed medium, whereas the powder concentrate is preferably diluted from about 0.1% by volume to about 7% by volume of to-be-foamed medium. It should be noted that the substantially non-aqueous liquid formulations of the present invention should not be diluted until the time of application to prevent the de-stabilization of the suspension properties within the composition. Those of ordinary skill in the art will recognize that aqueous foams are thermodynamically unstable and the role of each component of the fully diluted foamers is to promote foaming and/or to retard foam decay. Also, it will be recognized that foams generated from the fully diluted foamers will eventually collapse to leave primarily liquid wastes.

Although many laboratory investigations of aqueous foamers have been carried out in the absence of contaminants, the effect of contaminants is crucial for many applications. In an oilfield application, the foam may encounter hydrocarbons in a subterranean reservoir when applied either as a slug followed by a displacement agent or as a continuous injection. Although several components may be added sequentially to formulate a foam, it is preferable to use a single composition that incorporates a high-yield foamer and stabilizer. Hydrocarbons are well known agents for foam inhibition and breaking, and can have a destabilizing effect. The mechanism of foam collapse in the presence of hydrocarbons apparently involves emulsification of the hydrocarbon into foam lamellae. This allows the hydrocarbon to move inside the foam structure and have a destabilizing effect consistent with foam breaking.

In high-temperature applications, liquids foamed with the foamer composition according to the present invention develop higher viscosity than conventional fluids, which, in turn, increases its displacement capabilities. This foam can remain stable in the presence of hydrocarbon contamination left behind on a working surface, reducing the need for an intermediate treatment that would convert an oil-wet surface to a water-wet surface. In the case of the preferred embodiments, hydrocarbon and lower alcohol contamination exceeding 20% can be achieved before serious deterioration to the foam lamellae can be observed. This foamer composition also produces a stable foam in alkaline and acidic conditions. Foam remains stable even when subjected to 6% CaCl₂, 6% MgCl₂ or more. The stability of the foam can withstand the extreme conditions of pH, from 1 to 14, without showing deterioration to foam height or half-life.

Foaming compositions were evaluated by preparing a 1% by weight test solution of calcium chloride (“CaCl₂”), and adjusting the pH down or up, with hydrochloric acid (“HCl”) or sodium hydroxide (“NaOH”) solution, respectively. These parameters for the mix water were chosen to show the performance in hard water, and high and low pH conditions. One-hundred (100) ml of the test solution were used in the comparison of foaming properties. The foaming agent utilized is included in a composition of this invention in an amount in the range of from about 0.2% to about 5% by volume of the to-be-foamed aqueous medium. Where tolerance to hydrocarbon contamination was evaluated, off-road #2 diesel fuel was added, at concentrations of ten percent (10%) by volume of the aqueous media to be foamed, directly to the aqueous media and mixed to assure dispersion throughout the aqueous media. The mixture was mixed in a commercial Waring blender at about 12,000 rpm's for 1 minute. The foam was quickly transferred to a 1000 ml graduated glass cylinder where the total volume of the foam was measured and the expansion was calculated. The half-life of the foam, which is universally taken to be that time required for one-half (50%) of the aqueous solution initially foamed to drain from the foam, was then measured.

The following test procedure was used to evaluate and compare the various compositions:

1. All mixing was performed in a Commercial Waring Blender.

2. Alternatively, a 1% calcium chloride (CaCl₂) brine solution, with sodium hydroxide (NaOH) added to incrementally raise the pH to about 12.5, or a 10% by volume hydrochloric acid (HCl) solution, was employed as the aqueous alkaline/acid solution (collectively referred to as “brine” or “brine solution” for the purposes of this invention) in which the foaming additives were evaluated.

3. 100 ml of a brine solution was placed into the Waring blender, and circulated at about 200 rpm.

4. A known amount of surfactant and stabilizer were added to the brine and allowed to mix in until homogeneous.

5. 10 ml of “red” off-road diesel, where used to evaluate foam susceptibility to hydrocarbon contamination, were added before attempting to foam the mixture. “Off-road” diesel is a term commonly used to define those diesel streams that are not subject to fuel taxes, and may be void of any motor fuel additives such as detergents, pour-point depressants, etc. Off-road diesel usually contains a red dye to distinguish it from taxed diesel fuel.

6. The contents were blended at 12,000 rpm for one minute in the Waring blender, and the foam was poured into a 1,000 ml graduated glass cylinder.

7. A timer was started as the foam was poured, and stopped as the foam half-life is reached. Foam half-life is here defined as being the time it takes for the liquid-foam interface to reach the 50-ml mark on the graduated glass cylinder, since 100 ml of the brine was originally used to generate the foam.

### EXAMPLES

The present invention will be described in more detail with reference to the following examples. The quality of the foams produced in the preferred embodiments may be adjusted within the foamer composition concentrate by varying the dilution with water or water miscible solvent in the liquid concentrate embodiments, or by changing the amount and identity of the stabilizing agents in both the liquid and dry concentrates. Varying the concentration of the foamer composition in the foam can also change the foam quality.

The preferred embodiments may be prepared with fresh water make-up water while foam compositions of the present invention may be prepared of aqueous media, to include strongly alkaline or acidic solutions. This is an important consideration for remote locations where a large source of fresh water may not be available.

These examples are merely illustrative of the present invention and are not intended to be limiting. Foam height, and foam half-life data was taken for each test that led to the discovery of the present invention. “X” codes are experimental code names given to foamer compositions being tested.

### Example 1

The following table compares the foam and stability properties of several surfactants in the presence of 1% CaCl₂ brine@pH of 12.5, and hydrocarbons. 2 mL of the surfactant were added to 100 mL of the brine along with 10 mL of diesel.

| | Foam Height | Foam ½-Life |
|---|---|---|
| Surfactant | (mL) | (min:sec) |
| APG-325 | 130 | 0:00 |
| Alkyl Polyglycoside | | |
| AES-100 | 590 | 5:05 |
| Alkyl Ether Sulfate | | |
| Amphoteric SC | 200 | 0:00 |
| Amphoteric | | |
| Velvetex BA-35 | 360 | 1:00 |
| Cocamidopropyl Betaine | | |
| Tomadol 91-6 | 260 | 0:15 |
| Ethoxylated Linear Alcohol | | |
| Zonyl FSK | 320 | 0:30 |
| Fluorosurfactant | | |
| AO-17-7 | 250 | 0:00 |
| Polyoxyethylene, amine oxide | | |
| Rhodacal A-246/L | 350 | 1:50 |
| Sodium Alpha Olefin Sulfonate | | |
| Miranol Ultra C-37 | 130 | 0:05 |
| Sodium Cocoamphoacetate | | |

APG-325 is a product commercially available from Care Chemicals.

AES-100, and Velvetex BA-35 are products commercially available from ARC Products, Inc. Amphoteric SC, Tomadol 91-6, and AO-17-7 are products commercially available from Tomah Products, Inc.

Zonyl FSK is a product commercially available from ARC Products, Inc.

Rhodacal A-246/L, and Miranol Ultra C-37 are products commercially available from Rhodia.

### Example 2

The following table demonstrates the preference for Alkyl Ether Sulfates (AES) as expressed by CₓH₂ₓ₊₁O(C₂H₄O)_{y}SO₃M, where x is an integer from about 6 to 10, y is a value from 2 to about 4 and M=K⁺, Na⁺, and/or NH₄⁺. Surfactants with different values of x, y, and M are evaluated. 2 mL of the surfactant were added to 100 mL of 1% CaCl₂ brine, @pH of 12.5, and 10 mL of diesel.

| | | | Foam Height | Foam ½-Life |
|---|---|---|---|---|
| X | Y | M | (mL) | (min:sec) |
| 8-10 | 2.5 | Na⁺ | 610 | 5:10 |
| 8-10 | 1.5-2 | NH₄⁺ | 800 | 5:05 |
| 8-10 | 2.5 | NH₄⁺ | 590 | 5:10 |
| 6-10 | 2.5-3.5 | NH₄⁺ | 590 | 5:05 |

### Example 3

The following table demonstrates the improved foaming and stability properties of the preferred Ammonium Alkyl Ether Sulfate (AAES), with xanthan gum and Methoxypolyethylene Glycol (MPEG) stabilizer combinations in 100 mL of 1% CaCl₂ brine @ pH 12.5, and 10 mL of diesel.

| | Foam Height | Foam ½-Life |
|---|---|---|
| Foamer Composition | (mL) | (min:sec) |
| 1.5 mL AAES | 520 | 3:35 |
| 1.5 mL AAES + 0.15 g Xanthan Gum | 660 | 13:25 |
| 1.5 mL AAES + 0.15 g Xanthan Gum + | 620 | 30:00 |
| 2 mL 50% MPEG | | |

### Example 4

This table shows the effect of different polymers used with 1 mL of AAES surfactant, 2 ml of 50% MPEG solution, 100 mL of 1% CaCl₂ brine@pH of 12.5, and 10 mL hydrocarbons. (HEC=hydroxyethylcellulose, CMHEC=carboxymethyl hydroxyethylcellulose, HPG=hydroxypropyl guar, CMHPG=carboxymethyl hydroxypropyl guar, PVOH=polyvinylalcohol)

| Polymer | Foam Height (mL) | Foam ½-Life (min:sec) |
|---|---|---|
| CMHEC | 600 | 6:35 |
| CMHPG | 610 | 6:12 |
| Guar Gum | 590 | 5:15 |
| Gum Ghatti | 600 | 6:30 |
| HEC | 610 | 9:00 |
| HPG | 570 | 5:27 |
| PVOH | 650 | 5:40 |
| Welan Gum | 600 | 99:10 |
| Xanthan Gum | 620 | 111:10 |

### Example 5

The following table demonstrates the results leading to the preference of Polyoxyethylene Butyl Ether (POE-BE), in the present invention over an aqueous solvent and other non-aqueous solvents such as Polyethylene glycol. These examples show water miscible solvents improve the quality of the foam as compared to an aqueous solvent. The tests were run in 100 mL of 1% CaCl₂@pH 12.5, and 10 mL diesel.

| 51.2% AAES + 5.1% | | |
|---|---|---|
| XC + Solvent | Foam Height (mL) | Foam ½-Life (min:sec) |
| Water | 440 | 2:00 |
| PEG-200 | 530 | 8:35 |
| POE-BE | 750 | 9:05 |

### Example 6

The following table demonstrates the results obtained from foaming low pH and seawater solutions. 100 mL of either a 10% HCl solution or seawater, were used as the make-up water, with 10 mL of diesel as an added contaminant. 2 mL of Foamer A were used. (Foamer A is a foamer composition comprising 51.2% AAES+39.7% POE-BE+5.1% xanthan gum+4% fumed silica.)

| Solution to be Foamed | Foam Height (mL) | Foam ½-Life (min:sec) |
|---|---|---|
| 10% HCl solution | 410 | 4:10 |
| Seawater | 480 | 11:30 |

### Example 7

The following table demonstrates the results obtained from foaming a hardness-ion-rich brine. (Foamer B is a roamer composition comprising 45.87% AAES+45.87% POE-BE+4.59% xanthan gum+3.67% fumed silica.)

| 2 mL of Foamer B + | | |
|---|---|---|
| 100 mL of: | Foam Height (mL) | Foam ½-Life (min:sec) |
| 6% CaCl₂ | 750 | 21:00 |
| 6% MgCl₂ | 660 | 14:05 |
| 8% Salt | 760 | 18:45 |
| (2% CaCl₂ + 2% | | |
| MgCl₂ + 2% KCl + | | |
| 2% NaCl) | | |

### Example 8

The following table demonstrates the effect of increasing hydrocarbon contamination on one of the preferred foamer compositions using 100 mL of 1% CaCl₂ brine@pH 12.5 as the aqueous medium. (Foamer B is a roamer composition comprising 45.87% AAES+45.87% POE-BE+4.59% xanthan gum+3.67% fumed silica.)

| | Foam Height (mL) | Foam ½-Life (min:sec) |
|---|---|---|
| 2 mL of Foamer B | | |
| + No Diesel | 790 | 19:50 |
| + 5 mL diesel | 700 | 20:40 |
| + 10 mL diesel | 590 | 22:40 |
| + 15 mL diesel | 430 | 26:00 |
| + 20 mL diesel | 410 | 25:25 |
| 4 mL of Foamer B | | |
| + 20 mL Diesel | 400 | 75:00 |

### Example 9

The following table demonstrates the effect of increasing methanol contamination on ope of the preferred foamer compositions using 100 mL of drinking water as the aqueous medium. (Foamer B is a roamer composition comprising 45.87% AAES+45.87% POE-BE+4.59% xanthan gum+3.67% fumed silica.)

| Percentage | Maximum MeOH | Foam Height | Foam ½-Life |
|---|---|---|---|
| of Foamer B | concentration | (mL) | (min:sec) |
| 1.96 | 15 | 670 | 8:45 |
| 2.91 | 20 | 670 | 8:35 |
| 3.85 | 25 | 675 | 7:50 |
| 4.76 | 30 | 645 | 7:15 |

### Example 10

Foamer C is a preferred liquid foamer formulation comprising 41.1% AAES+4.11% MPEG+4.11% xanthan gum+3.16% fumed silica+47.5% POE-BE. The foam height and foam half-life results for this example can be found in Table 1.

### Example 11

Foamer A is a preferred liquid foamer composition comprising 51.2% AAES+39.7?/POE-BE+5.1% xanthan gum+4% fumed silica. The foam height and foam half-life results for this example can be found in Table 1.

### Example 12

Foamer D is a preferred solid/semi-solid foamer composition comprising 31.8% AAES+31.8% MPEG+3.2% xanthan gum+26.7% diatomaceous earth+6.7% fumed silica. The foam height and foam half-life results for this example can be found in Table 1.

Table 1

The following table displays the results obtained from some of the preferred foamer compositions mentioned in Examples 10, 11, and 12. The test was conducted using 100 mL of 1% CaCl₂@pH 12.5, with 10 mL of diesel.

| Foamer | Foam Height (mL) | Foam Half-Life (min:sec) |
|---|---|---|
| 2 mL of Example 10 | 690 | 16:20 |
| 2 mL of Example 11 | 690 | 20:45 |
| 2 g of Example 12 | 600 | 26:30 |

Although preferred embodiments of the present invention have been illustrated and described in some detail herein, various substitutions and modifications may be made to the compositions of the invention without departing from the scope and spirit of the appended claims.

What is claimed is:

1. A non-aqueous foamer composition, comprising:
(a) an alcohol ether sulfate salt;
(b) a water miscible solvent; and
(c) a polymer selected from the group consisting of natural polymers, modified natural polymers, synthetic polymers, and combinations thereof.

2. The non-aqueous foamer composition, further comprising: (d) a suspending agent.

3. The non-aqueous foamer composition of claims 1 or 2 wherein the alcohol ether sulfate salt is an alkali metal salt, an ammonium salt, or combinations thereof.

4. The non-aqueous foamer composition of claim 3 wherein the alcohol ether sulfate salt comprises the form:
CₓH₂ₓ₊₁O(C₂H₄O)_{y}SO₃M, where x is an integer from about 6 to about 10, y is a value from about 1 to about 10 and M=Na (sodium)₉ K (potassium), NH₄ (ammonium), or combinations thereof.

5. The non-aqueous foamer composition of claim 4 wherein the alcohol ether sulfate salt has x equal from about 6 to about 8, and y is from about 2 to about 4.

6. The non-aqueous foamer of claim 4 wherein the alcohol ether sulfate salt has M preferably as NH₄ (ammonium).

7. The non-aqueous foamer composition of claims 1 or 2 wherein the water miscible solvent is selected from the group consisting of aliphatic alcohols, aliphatic ketones, aliphatic esters, aliphatic glycols, aliphatic polyglycols, aliphatic glycol ethers, and mixtures thereof.

8. The non-aqueous foamer composition of claim 1 or 2 wherein the water miscible solvent is selected from the group consisting of methanol, ethanol, propanol, isopropanol, butanol, isobutanol, furfural alcohol, tetrahydrofurfural alcohol, acetone, methyl ethyl ketone, diethyl ketone, diacetone alcohol, ethylene glycol, propylene glycol, butylene glycol, glycerine, hexylene glycol, ethyl acetate, butyl acetate, ethylene glycol methyl ether acetate, diethylene glycol methyl ether acetate, diethylene glycol, triethylene glycol, tetraethylene glycol, polyethylene glycol, dipropylene glycol, tripropylene glycol, polypropylene glycol, ethylene oxide propylene oxide block copolymers, ethylene glycol methyl ether, ethylene glycol ethyl ether, ethylene glycol butyl ether, ethylene glycol dimethyl ether, ethylene glycol methyl butyl ether, diethylene glycol methyl ether, diethylene glycol butyl ether, diethylene glycol dimethyl ether, diethylene glycol methyl butyl ether, dipropylene glycol methyl ether, dipropylene glycol butyl ether, dipropylene glycol dimethyl ether, triethylene glycol methyl ether, triethyleneglycol butyl ether, tripropylene glycol methyl ether, tripropylene glycol butyl ether, polyoxyethylene butyl ether, polyoxypropylene butyl ether, tetrahydrofuran, dimethylformamide, and combinations thereof.

9. The non-aqueous foamer composition of claim 2 wherein the suspending agent is selected from the group consisting of amorphous and fumed silicas.

10. The non-aqueous foamer composition of claims 1 or 2 wherein the polymer is selected from the group consisting of gum ghatti, gum arabic, gum tragacanth, locust bean gum, gum karaya, guar gum and alkyl, hydroxyalkyl, carboxyalkyl, carboxyalkylhydroxyalkyl and cationic derivatives of guar and mixtures thereof, carrageenan, and alkyl-, hydroxyalkyl-, carboxyalkyl-, hydroxyalkyl carboxyalkyl-derivatives of cellulose, polyimines, poly(acrylic acid), poly(methacrylic acid), poly(maleic acid-co-ethylene), poly(maleic acid-co-ethylvinylether), poly(maleic acid-co-butylvinylether), poly(maleic acid-co-styrene), poly(maleic acid-co-indene), poly(vinylsulforic acid), poly(styrenesulfonic acid), dextransulfate, poly(L-glutamic acid), and combinations thereof, hydrophobically modified guar, hydrophobically modified hydroxyalkyl guar, hydrophobically modified carboxyalkyl guar, hydrophobically modified carboxyalkyl hydroxyalkyl guar, hydrophobically modified cationic guar gum, pectin, alginates, gum acacia, alkyl ethers of cellulose, hydroxyalkyl methyl cellulose, hydrophobicaily modified hydroxyalkyl cellulose, hydrophobically modified carboxyalkyl hydroxyalkyl cellulose, hydrophobically modified carboxyalkyl cellulose, hydrophobically modified alkyl ethers of cellulose, hydrophobically modified hydroxyalkyl methyl cellulose, starch, tara gum, biopolymers such as xanthan gum or welan gum, succinoglucans, and their alkyl, hydroxyalkyl, carboxyalkyl, hydroxyalkyl carboxyalkyl, cationic derivatives, and mixtures thereof.

11. The non-aqueous foamer composition of claims 1 or 2 wherein the polymer is xanthan gum, welan gum, and combinations thereof.

12. The non-aqueous foamer composition of claims 1 or 2 wherein the polymer is methoxypolyethylene glycols of the formula CH₃O—(CH₂—CH₂—O)ₙ—H where n is in the range of 100 to 150.

13. The non-aqueous foamer composition of claims 1 or 2 wherein the polymer is combinations of xanthan gum, welan gum, and methoxypolyethylene glycols of the formula CH₃O—(CH₂—CH₂—O)ₙ—H where n is in the range of 100 to 150.

14. The non-aqueous foamer composition of claim 1 wherein:
(a) the alcohol ether sulfate salt concentration ranges from about 10% to about 85% by weight of non-aqueous foamer composition;
(b) the water miscible solvent concentration ranges from about 15% to about 80% by weight of non-aqueous roamer composition; and
(c) the polymer concentration ranges from about 0% to about 10% by weight of non-aqueous foamer composition.

15. The non-aqueous foamer composition of claim 2 wherein:
(a) the alcohol ether sulfate salt concentration ranges from about 10% to about 85% by weight of non-aqueous foamer composition;
(b) the water miscible solvent concentration ranges from about 15% to about 80% by weight of non-aqueous roamer composition;
(c) the polymer concentration ranges from about 0% to about 10% by weight of non-aqueous foamer composition; and
(d) the suspending agent concentration ranges from about 0% to about 15% by weight of non-aqueous foamer composition.

16. The non-aqueous foamer composition of claim 1 wherein:
(a) the alcohol ether sulfate salt is preferred in a concentration range from about 25% to about 65% by weight of non-aqueous roamer composition;
(b) the water miscible solvent concentration is preferred in a range from about 30% to about 65% by weight of non-aqueous foamer composition; and
(c) the polymer concentration is preferred in a range from about 0% to about 10% by weight of non-aqueous foamer composition.

17. The non-aqueous roamer composition of claim 2 wherein:
(a) the alcohol ether sulfate salt is preferred in a concentration range from about 25% to about 65% by weight of non-aqueous foamer composition;
(b) the water miscible solvent concentration is preferred in a range from about 30% to about 65% by weight of non-aqueous roamer composition;
(c) the polymer concentration is preferred in a range from about 1% to about 7% by weight of non-aqueous roamer composition; and
(d) the suspending agent concentration is preferred in a range from about 1% to about 10% by weight of non-aqueous foamer composition.

18. The non-aqueous foamer composition of claim 1 wherein:
(a) the alcohol ether sulfate salt is most preferred in a concentration range from about 36% to about 60% by weight of non-aqueous foamer composition;
(b) the water miscible solvent concentration is most preferred in a range from about 36% to about 55% by weight of non-aqueous foamer composition; and
(c) the polymer concentration is most preferred in a range from about 0% to about 7% by weight of non-aqueous foamer composition.

19. The non-aqueous foamer composition of claim 2 wherein:
(a) the alcohol ether sulfate salt is most preferred in a concentration range from about 36% to about 60% by weight of non-aqueous foamer composition;
(b) the water miscible solvent concentration is most preferred in a range from about 36% to about 55% by weight of non-aqueous foamer composition;
(c) the polymer concentration is most preferred in a range from about 2% to about 6% by weight of non-aqueous foamer composition; and
(d) the suspending agent concentration is most preferred in a range from about 2% to about 7% by weight of non-aqueous foamer composition.

20. The non-aqueous roamer composition of claim 1 wherein the alcohol ether sulfate concentration is 60% and the water miscible solvent concentration is 40%.

21. The non-aqueous roamer composition of claim 2 wherein the alcohol ether sulfate concentration is 45.9%, the water miscible solvent concentration is 45.9%, the polymer concentration is 4.6%, and the suspending agent concentration is 3.6%.

22. An aqueous foamer composition, comprising:
(a) an alcohol ether sulfate salt;
(b) water miscible solvent;
(c) polymer; and
(d) water.

23. The aqueous foamer composition of claim 22 wherein the alcohol ether sulfate salt is an alkali metal salt, an ammonium salt, or combinations thereof.

24. The aqueous foamer composition of claim 23 wherein the alcohol ether sulfate salt comprises the form:
CₓH₂ₓ₊₁O(C₂H₄O)_{y}SO₃M, where x is an integer from about 6 to about 10, y is a value from about 1 to about 10 and M=Na (sodium), K (potassium), NH₄ (ammonium), or combinations thereof.

25. The aqueous foamer composition of claim 24 wherein the alcohol ether sulfate salt has M as NH₄ (ammonium).

26. The aqueous roamer composition of claim 22 wherein the water miscible solvent is selected from the group consisting of aliphatic alcohols, aliphatic ketones, aliphatic esters, aliphatic glycols, aliphatic polyglycols, aliphatic glycol ethers, and mixtures thereof.

27. The aqueous foamer composition of claim 22 wherein the water miscible solvent is selected from the group consisting of methanol, ethanol, propanol, isopropanol, butanol, isobutanol, furfural alcohol, tetrahydrofurfural alcohol, acetone, methyl ethyl ketone, diethyl ketone, diacetone alcohol, ethylene glycol, propylene glycol, butylene glycol, glycerine, hexylene glycol, ethyl acetate, butyl acetate, ethylene glycol methyl ether acetate, diethylene glycol methyl ether acetate, diethylene glycol, triethylene glycol, tetraethylene glycol, polyethylene glycol, dipropylene glycol, tripropylene glycol, polypropylene glycol, ethylene oxide propylene oxide block copolymers, ethylene glycol methyl ether, ethylene glycol ethyl ether, ethylene glycol butyl ether, ethylene glycol dimethyl ether, ethylene glycol methyl butyl ether, diethylene glycol methyl ether, diethylene glycol butyl ether, diethylene glycol dimethyl ether, diethylene glycol methyl butyl ether, dipropylene glycol methyl ether, dipropylene glycol butyl ether, dipropylene glycol dimethyl ether, triethylene glycol methyl ether, triethyleneglycol butyl ether, tripropylene glycol methyl ether, tripropylene glycol butyl ether, polyoxyethylene butyl ether, polycxypropylene butyl ether, tetrahydrofuran, dimethylformamide, and combinations thereof.

28. The aqueous foamer composition of claim 22 wherein the polymer is selected from the group consisting of gum ghatti, gum arabic, gum tragacanth, locust bean gum, gum karaya, guar gum and alkyl, hydroxyalkyl, carboxyalkyl, carboxyalkyl-hydroxyalkyl and cationic derivatives of guar and mixtures thereof, carrageenan, and alkyl-, hydroxyalkyl-, carboxyalkyl-, hydroxyalkyl carboxyalkyl-derivatives of cellulose, polyimines, poly(acrylic acid), poly(methacrylic acid), poly(maleic acid-co-ethylene), poly(maleic acid-co-ethylvinylether), poly(maleic acid-co-butylvinylether), poly(maleic acid-co-styrene), poly(maleic acid-co-indene), poly(vinylsulfuric acid), poly(styrenesulfonic acid), dextransulfate, poly(L-glutamic acid), and combinations thereof, hydrophobically modified guar, hydrophobically modified hydroxyalkyl guar, hydrophobically modified carboxyalkyl guar, hydrophobically modified carboxyalkyl hydroxyalkyl guar, hydrophobically modified cationic guar gum, pectin, alginates, gum acacia, alkyl ethers of cellulose, hydroxyalkyl methyl cellulose, hydrophobically modified hydroxyalkyl cellulose, hydrophobically modified carboxyalkyl hydroxyalkyl cellulose, hydrophobically modified carboxyalkyl cellulose, hydrophobically modified alkyl ethers of cellulose, hydrophobically modified hydroxyalkyl methyl cellulose, starch, tara gum, biopolymers such as xanthan gum or welan gum, succinoglucans, and their alkyl, hydroxyalkyl, carboxyalkyl, hydroxyalkyl carboxyalkyl, cationic derivatives, and mixtures thereof.

29. The aqueous foamer composition of claim 22 wherein the polymer is xanthan gum, welan gum, and combinations thereof.

30. The aqueous foamer composition of claim 22 wherein the polymer is methoxypolyethylene glycols of the formula CH₃O—(CH₂—CH₂—O)ₙ—H where n is in the range of 100 to 150.

31. The aqueous foamer composition of claim 22 wherein the polymer is combinations of xanthan gum, welan gum, and methoxypolyethylene glycols of the formula CH₃O—(CH₂—CH₂—O)ₙ—H where n is in the range of 100 to 150.

32. The aqueous foamer composition of claim 22 wherein:
(a) the alcohol ether sulfate salt concentration ranges from about 15% to about 85% by weight of aqueous foamer composition;
(b) the water miscible solvent concentration ranges from about 1% to about 40% by weight of aqueous foamer composition;
(c) the polymer concentration ranges from about 0% to about 10% by weight of aqueous roamer composition; and
(d) water forming the balance to 100%.

33. The aqueous foamer composition of claim 22 wherein:
(a) the alcohol ether sulfate salt is preferred in a concentration range from about 25% to about 70% by weight of aqueous foamer composition;
(b) the water miscible solvent concentration is preferred in a range from about 3% to about 30% by weight of aqueous foamer composition;
(c) the polymer concentration is preferred in a range from 0% to about 7% by weight of aqueous foamer composition; and
(d) water forming the balance to 100%.

34. The aqueous foamer composition of claim 22 wherein:
(a) the alcohol ether sulfate salt is most preferred in a concentration range from about 35% to about 60% by weight of aqueous foamer composition;
(b) the water miscible solvent concentration is most preferred in a range from about 5% to about 15% by weight of aqueous foamer composition;
(c) the polymer concentration is most preferred in a range from 0% to about 5% by weight of aqueous foamer composition; and
(d) water forming the balance to 100%.

35. The aqueous foamer composition of claim 22 wherein the alcohol ether sulfate concentration is 59.5%, the water miscible solvent concentration is 10.5%, and the water concentration is 30%.

36. A solid/semi-solid foamer composition, comprising:
(a) an alcohol ether sulfate salt;
(b) an adsorbing/absorbing agent; and
(c) a polymer selected from the group consisting of natural polymers, modified natural polymers, synthetic polymer, and combinations thereof.

37. The solid/semi-solid foamer composition of claim 36, further comprising: (d) a free-flowing agent.

38. The solid/semi-solid foamer composition of claims 36 or 37 wherein the alcohol ether sulfate salt is an alkali metal salt, an ammonium salt, or combinations thereof.

39. The solid/semi-solid foamer composition of claim 38 wherein the alcohol ether sulfate salt comprises the form: CₓH₂ₓ₊₁O(C₂H₄O)_{y}SO₃M, where x is an integer from about 6 to about 10, y is a value from about 1 to about 10 and M=Na (sodium), K (potassium), NH₄ (ammonium), or combinations thereof.

40. The solid/semi-solid foamer composition of claim 39 wherein the alcohol ether sulfate salt has x equal from about 6 to about 8, and y is from about 2 to about 4.

41. The solid/semi-solid foamer composition of claim 39 wherein said alcohol ether sulfate salt has M preferably as NH₄ (ammonium).

42. The solid/semi-solid foamer composition of claims 36 or 37 wherein the adsorbing/absorbing agent is ammonium and alkaline metal carbonate, silicas, light soda ash, diatomaceous earth, zeolite, micas and other like adsorbing/absorbing agents.

43. The solid/semi-solid foamer composition of claims 36 or 37 wherein the polymer is selected from the group consisting of gum ghatti, gum arabic, gum tragacanth, locust bean gum, gum karaya, guar gum and alkyl, hydroxyalkyl, carboxyalkyl, carboxyalkylhydroxyalkyl and cationic derivatives of guar and mixtures thereof, carrageenan, and alkyl-, hydroxyalkyl-, carboxyalkyl-, hydroxyalkyl carboxyalkyl-derivatives of cellulose, polyimines, poly(acrylic acid), poly(methacrylic acid), poly(maleic acid-co-ethylene), poly(maleic acid-co-ethylvinylether), poly(maleic acid-co-butylvinylether), poly(maleic acid-co-styrene), poly(maleic acid-co-indene), poly(vinylsulfuric acid), poly(styrenesulfonic acid), dextransulfate, poly(L-glutamic acid), and combinations thereof, hydrophobically modified guar, hydrophobically modified hydroxyalkyl guar, hydrophobically modified carboxyalkyl guar, hydrophobically modified carboxyalkyl hydroxyalkyl guar, hydrophobically modified cationic guar gum, pectin, alginates, gum acacia, alkyl ethers of cellulose, hydroxyalkyl methyl cellulose, hydrophobically modified hydroxyalkyl cellulose, hydrophobically modified carboxyalkyl hydroxyalkyl cellulose, hydrophobically modified carboxyalkyl cellulose, hydrophobically modified alkyl ethers of cellulose, hydrophobically modified hydroxyalkyl methyl cellulose, starch, tara gum, biopolymers such as xanthan gum or welan gum, succinoglucans, and their alkyl, hydroxyalkyl, carboxyalkyl, hydroxyalkyl carboxyalkyl, cationic derivatives, and mixtures thereof.

44. The solid/semi-solid foamer composition of claims 36 or 37 wherein the polymer is xanthan gum, welan gum, and combinations thereof.

45. The solid/semi-solid foamer composition of claims 36 or 37 wherein the polymer is methoxypolyethylene glycols of the formula CH₃O—(CH₂—CH₂—O)ₙ—H where n is in the range of 100 to 150.

46. The solid/semi-solid foamer composition of claims 36 or 37 wherein the polymer is combinations of xanthan gum, welan gum, and methoxypolyethylene glycols of the formula CH₃O—(CH₂—CH₂—O)ₙ—H where n is in the range of 100 to 150.

47. The solid/semi-solid roamer composition of claim 37 wherein the free-flowing agent is selected from the group consisting of amorphous and fumed silicas.

48. The solid/semi-solid foamer composition of claim 36 wherein:
(a) the alcohol ether sulfate salt concentration ranges from about 15% to about 85% by weight of foamer composition;
(b) the adsorbing/absorbing agent concentration ranges from about 0% to about 70% by weight of foamer composition; and
(c) the polymer concentration ranges from about 0% to about 85% by weight of foamer composition.

49. The solid/semi-solid foamer composition of claim 37 wherein:
(a) the alcohol ether sulfate salt concentration ranges from about 15% to about 85% by weight of foamer composition;
(b) the adsorbing/absorbing agent concentration ranges from about 0% to about 70% by weight of foamer composition;
(c) the polymer concentration ranges from about 0% to about 85% by weight of foamer composition; and
(d) the free-flowing agent concentration ranges from about 0% to about 50% by weight of foamer composition.

50. The solid/semi-solid foamer composition of claim 36 wherein:
(a) the alcohol ether sulfate salt is preferred in a concentration range from about 20% to about 60% by weight of foamer composition;
(b) the adsorbing/absorbing agent concentration is preferred in a range from about 10% to about 60% by weight of foamer composition; and
(c) the polymer concentration is preferred in a range from about 10% to about 60% by weight of roamer composition.

51. The solid/semi-solid roamer composition of claim 37 wherein:
(a) the alcohol ether sulfate salt is preferred in a concentration range from about 20% to about 60% by weight of foamer composition;
(b) the adsorbing/absorbing agent concentration is preferred in a range from about 10% to about 60% by weight of foamer composition;
(c) the polymer concentration is preferred in a range from about 10% to about 60% by weight of foamer composition; and
(d) the free-flowing agent concentration is preferred in a range from about 1% to about 30% by weight of foamer composition.

52. The solid/semi-solid foamer composition of claim 36 wherein:
(a) the alcohol ether sulfate salt is most preferred in a concentration range from about 28% to about 51% by weight of foamer composition;
(b) the adsorbing/absorbing agent concentration is most preferred in a range from about 20% to about 52% by weight of roamer composition; and
(c) the polymer concentration is most preferred in a range from about 20% to about 51% by weight of roamer composition.

53. The solid/semi-solid foamer composition of claim 37 wherein:
(a) the alcohol ether sulfate salt is most preferred in a concentration range from about 28% to about 51% by weight of roamer composition;
(b) the adsorbing/absorbing agent concentration is most preferred in a range from about 20% to about 52% by weight of foamer composition;
(c) the polymer concentration is most preferred in a range from about 20% to about 51% by weight of foamer composition; and
(d) the free-flowing agent concentration is most preferred in a range from about 1% to about 10% by weight of foamer composition.

54. The solid/semi-solid foamer composition of claim 36 wherein the alcohol ether sulfate concentration is 29%, the polymer concentration is 30%, and the absorbing agent is 41%.

55. The solid/semi-solid foamer composition of claim 37 wherein the alcohol ether sulfate concentration is 31.7%, the polymer concentration is 34.9%, the absorbing agent is 26.7%, and the free-flow agent is 6.7%.

56. A foam, comprising:
(a) the non-aqueous foamer composition of claim 1 or claim 2, or the aqueous roamer composition of claim 22, or the solid/semi-solid foamer composition of claim 36 or claim 37;
(b) aqueous solution or water; and
(c) gas.

57. The foam of claim 56 wherein the aqueous solution is selected from the group consisting of natural-fresh and brackish waters, sea water, sodium-, potassium-, and ammonium-chloride brines, waters acidified by the presence of hydrochloric, sulfuric, acetic, formic acid, or mixtures thereof, and alkali waters made alkaline by the presence of salts of hydroxides, carbonates, bicarbonates, and mixtures thereof.

58. The foam of claim 56 wherein the gas fraction ranges from about 5 percent of the total weight of the foam to about 95 percent of the total weight of the foam, the balance being made up from the aqueous solution or water and one of the foamer compositions of claims 1, 2, 22, 36, and 37.

59. A method of foaming an aqueous solution, comprising adding to the aqueous solution a non-aqueous foamer composition, comprising an alcohol ether sulfate salt, a water miscible solvent, and a polymer selected from the group consisting of natural polymers, modified natural polymers, synthetic polymers, and combinations thereof to form an aqueous foam.

60. The method of claim 59 wherein the aqueous foam may be contacted by contaminants including hydrocarbons, alcohols, brines, hardness ions, acids, bases, and combinations thereof.

61. The method of claim 60 wherein the contaminants, separately or collectively, may comprise up to about 50% of the aqueous fraction of the foam, by weight.

62. A method of foaming an aqueous solution, comprising making the aqueous solution acidic by adding up to about 30% by weight mineral acid through the addition of a non-aqueous foamer comprising an alcohol ether sulfate, a water miscible solvent, and a polymer selected from the group consisting of natural polymers, modified natural polymers, synthetic polymers, and combinations thereof to form an aqueous-acid foam.

63. The method of claim 62 wherein the aqueous-acid foam may be contacted by contaminants including hydrocarbons, alcohols, brines, hardness ions, acids, bases, and combinations thereof.

64. The method of claim 63 wherein the contaminants, separately or collectively, may comprise up to about 50% by weight of the aqueous-acid fraction of the foam.

65. The method of claims 60 or 63 wherein the alcohols are aliphatic alcohols having less than 7 carbons.

66. The method of claims 60 or 63 wherein the acids are mineral acids, carboxylic acids, and combinations thereof.

67. The method of claim 66 wherein the mineral acids may be selected from the group consisting of hydrochloric acid, hydrofluoric acid, sulfuric acid, nitric acid, phosphoric acid, boric acid, and combinations thereof.

68. The method of claim 66 wherein the carboxylic acids may be selected from the group consisting of formic acid, acetic acid, propionic acid, citric acid, lactic acid, tartaric acid, glycolic acid, and combinations thereof.

69. The method of claims 60 or 63 wherein the bases are alkaline oxides, hydroxides, carbonates, amines, and combinations thereof.

70. The method of claim 69 wherein the alkaline oxides may be selected from the group consisting of calcium oxide, magnesium oxide, and combinations thereof.

71. The method of claim 69 wherein the hydroxides may be selected from the group consisting of sodium hydroxide, potassium hydroxide, ammonium hydroxide, calcium hydroxide, magnesium hydroxide, and combinations thereof.
